(19) United States
(12) Patent Application Publication
(10) Pub. No.: US 2008/0073358 A1
(43) Pub. Date: Mar. 27, 2008

(54) Self-Cooling Bottle

(75) Inventors: Pierre Jeuch, Saint Aubin (FR); Lionel Frantz, Paris (FR); Fadi Khairallah, Versailles (FR)

Correspondence Address: SUGHRUE MION, PLLC, 2100 PENNSYLVANIA AVENUE, N.W., SUITE 800, WASHINGTON, DC, 20037, US

(73) Assignee: THERMAGEN SA, Gif Sur Yvette (FR)

(21) Appl. No.: 11/577,397

(22) PCT Filed: Oct. 11, 2005
(86) PCT No.: PCT/FR05/02509

§ 371 Date: Apr. 17, 2007

(30) Foreign Application Priority Data
Oct. 18, 2004 (FR) 04292474.6

(51) Int. Cl. B65D 83/72; B23P 19/04; B65D 23/08

(52) U.S. Cl. 220/592.18; 215/12.2; 29/700

(57) ABSTRACT

A self-refrigerating packaging item comprising a glass bottle (1), forming a first cavity (10) containing a product that is to be refrigerated, a second cavity (20) forming an evaporator and containing a refrigerating liquid and the vapor thereof, and a third cavity (30) containing means for absorption pumping of the vapor; and means (40) enabling communication between the second and third cavities (20, 30). The first and second cavities (10, 20) have a common metal wall (15) forming a heat exchanger and the bottom of the bottle (1). The self-refrigerating bottle has a tight, simple design and can be produced at low cost.

The present invention relates to a packaging item comprising a glass bottle associated with a device making it possible to cool its content using an evaporation and adsorption method. The principle of such a cooling method consists in evaporating a liquid, known as the cooling or refrigerating liquid, under the effect of a depression maintained by pumping the vapors of said liquid. The invention applies to the cooling of the drink which is contained in a glass bottle and in particular the cooling of an alcoholic drink.

One aim of the present invention is consequently to allow consumption of a drink, for example champagne, at an ideal temperature, anywhere and at any time of day.

Two main physical methods for cooling the content of a packaging item or closed vessel exist: firstly, the method of cooling by expansion of gas according to classical laws of thermodynamics relating temperature and pressure and, secondly, the method of cooling by evaporation and adsorption, the principle of which consists in evaporating a liquid under the effect of a depression maintained by adsorption of the vapors of said liquid.

Implementation of the method of cooling by evaporation and adsorption is known and has been the object of considerable research in the prior alt. Numerous devices have been proposed, associating an evaporator containing a liquid to be evaporated and a reservoir that contains an adsorbent, in particular for application to packaging items for self-cooling drinks of the metal can type.

For example, EP-A-1 164 341 and WO 03/073019 in the name of the present applicant together with patent application WO 01/10738 disclose self-cooling drink packaging items and their manufacture. The packaging items disclosed in those documents employ metal containers such as cans, to hold the drink to be cooled. The use of a metal container is however not appropriate in the case of certain drinks, for example champagne or white wine.

U.S. Pat. No. 6,128,906 discloses a self-cooling packaging item associating a bottle with a refrigeration device containing a pressurized gas. The cooling method employed is consequently that stated above employing gas expansion, and not a method of cooling by evaporation and adsorption. This cooling method has several disadvantages. Firstly, the gas cartridge takes up a large proportion of the volume of the drink to be cooled, this being rendered necessary by the amount of gas needed to cool the drink. Secondly, the cost price of a compressed gas cartridge is high and there is a limited choice of gases that are compatible with requirements of ecology.

The self-cooling bottle disclosed in U.S. Pat. No. 6,128,906 can be made of plastic or glass and the refrigeration device is of metal in order to withstand the elevated pressure of the compressed gas and to ensure good heat transfer between the refrigeration system and the drink to be cooled. In the case of a glass bottle, assembling the metal refrigeration device into the glass bottom of a bottle requires shaping of the bottle and the use of two intermediate parts of complex shape—identified by reference numerals 130 and 144 in FIG. 4 of that patent. Sealing needs to be insured at three points: between the bottle and the first intermediate part, between the gas cartridge and the second intermediate part, and between the two intermediate parts. This triple sealing using seals—identified by reference numerals 136, 146 and 150 in FIG. 4 of the said patent—implies complex and costly construction of the packaging item, with poorly reliable sealing. Such complex securement results from the shape and weight of the compressed gas refrigerating device that is to be secured into the base of the bottle.

There is consequently a need for a packaging item comprising a glass bottle associated with a device making it possible to cool the content thereof, which can be produced in a simplified manner and at reduced cost.

To this end, the present invention provides an assembly of a glass bottle with a metal heat exchanger directly constituting the base or bottom of the bottle.

More particularly, the invention provides a self-cooling packaging item comprising:

a glass bottle constituting a first cavity containing a product to be cooled;

a second cavity forming an evaporator and containing a refrigerating liquid and its vapor;

a third cavity containing means for pumping by adsorption of said vapor;

means for putting said second and third cavities into communication;

the first and second cavities having a common metal wall forming a heat exchanger and constituting a base of the bottle.

According to one embodiment, the heat exchanger has a food quality protective coating on its face internal to the first cavity.

According to further embodiments, the protective coating includes silica or enamel.

According to a further embodiment, the self-cooling packaging item comprises a sealed mechanical joint between the glass of the bottle and the heat exchanger.

According to one embodiment, the sealed joint comprises sealing of the glass of the bottle with a protective coating of the heat exchanger.

The self-cooling packaging item in a further embodiment comprises a mechanical joint and a seal between the glass of the bottle and the heat exchanger.

The mechanical joint can be constituted by folding over of the metal of the base into a channel of the wall of the bottle.

In a different embodiment, the mechanical joint is constituted by screwing the heat exchanger onto the glass wall of the bottle.

The seal could be an O-ring arranged inside a channel of the wall of the bottle The seal could also be a flat seal arranged on an edge of the wall of the bottle.

According to one embodiment, the heat exchanger constituting the base of the bottle has an extension over a portion of the outer wall of the bottle.

In a further embodiment, a can containing the third cavity is assembled onto the bottle by brazing onto the extension of the heat exchanger.

The invention also provides a method of producing a self-cooling packaging item comprising:

supplying a glass bottle without a base;

assembling a metal wall forming a heat exchanger to the wall of the bottle to constitute a base of said bottle;

assembling a can containing means for pumping by adsorption onto the heat exchanger of the bottle, a lid of the can of adsorbent and the heat exchanger of the bottle defining an evaporator.

In one embodiment, the step of assembling the heat exchanger to the glass of the bottle is performed by sealing the glass of the bottle to a protective coating of the heat exchanger.

According to a further embodiment, the step of assembling the heat exchanger to the glass of the bottle comprises the steps consisting of screwing the heat exchanger onto a glass wall of the bottle and placing a seal between the glass of the bottle and the heat exchanger.

According to a further embodiment, the step of assembling the heat exchanger to the glass of the bottle comprises the steps consisting in forcing the metal of the heat exchanger into a channel of the glass wall of the bottle and placing a seal between the glass of the bottle and the heat exchanger.

According to embodiments the can of adsorbent is assembled onto the heat exchanger after assembling the heat exchanger onto the bottle or prior to assembly of the heat exchanger onto the bottle.

According to one embodiment, the can of adsorbent is assembled onto the heat exchanger by brazing.

The invention also provides a self-cooling assembly comprising:

a self-cooling packaging item according to the invention;

a stand comprising a hollow stem adapted to receive the head of the bottle.

In one embodiment, the stand further comprises at least one boss over which an upside-down glass can be slipped.

According to a further embodiment, at least two glasses with feet are arranged on the stand, the feet being shaped so as to provide support over two arcs on opposite sides of the bottle.

The particular features and advantages of the present invention will become more apparent from reading the description which follows given by way of non-limiting illustrative example, with reference to be attached drawings.

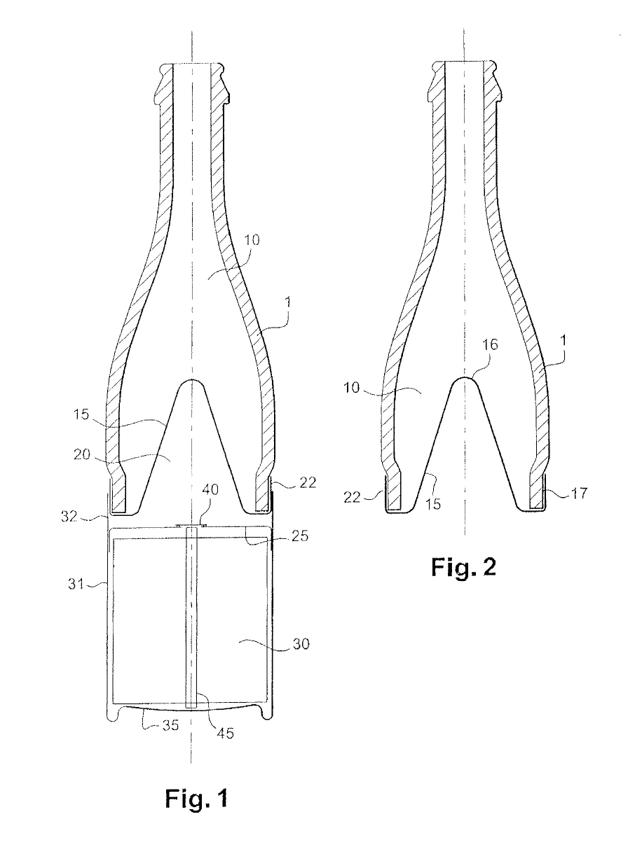

FIG. 1 is a diagrammatic view of a self-cooling packaging item according to the invention;

FIG. 2 shows the assembly of a bottle with a heat exchanger according to a first embodiment;

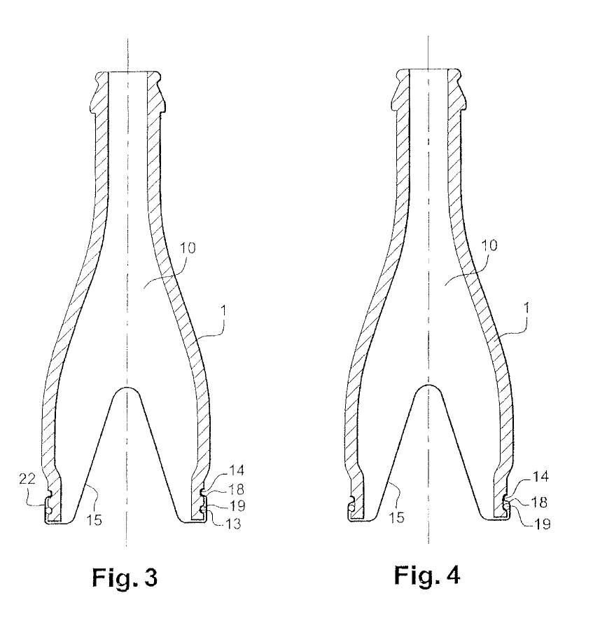

FIG. 3 shows the assembly of a bottle with a heat exchanger according to a second embodiment;

FIG. 4 shows the assembly of a bottle with a heat exchanger according to a variation on this second embodiment;

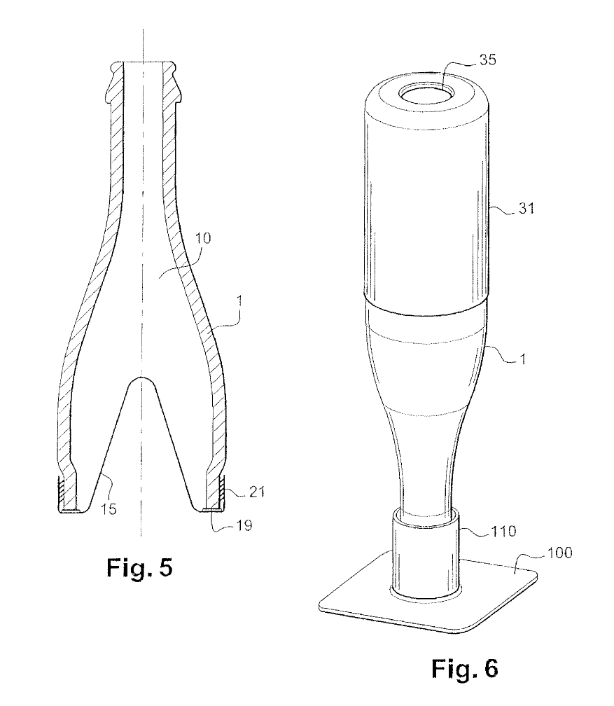

FIG. 5 shows the assembly of a bottle with a heat exchanger according to a third embodiment:

FIG. 6 shows the self-cooling packaging, on a stand for implementing cooling;

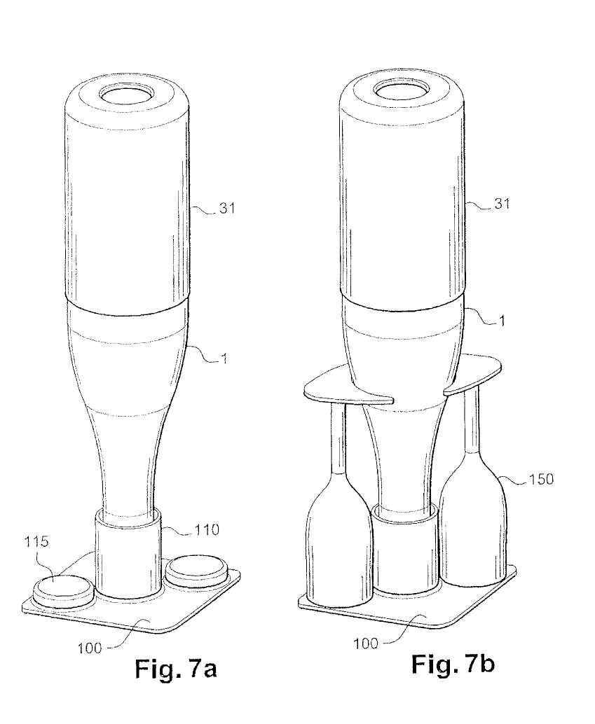

FIGS. 7a and 7b show an alternative to the stand in FIG. 6.

The self-cooling packaging item according to the invention will be described with reference to FIG. 1.

The self-cooling packaging item according to the invention comprises a glass bottle 1 constituting a first cavity 10 containing a consumable drink to be cooled, for example wine or champagne, and a second cavity 20 forming an evaporator. The first cavity 10 and second cavity 20 have a common metal wall 15 that constitutes a heat exchanger, this wall 15 forming the base of bottle 1. In particular, the metal heat exchanger 15 is directly connected to the glass bottom of the bottle. Heat exchanger 15 advantageously has a conical shape with ribs in order to favor heat exchange by convection in first cavity 10.

The packaging item also includes a metal can 31 that delimits a third cavity 30 containing pumping means by adsorption of the vapor of a refrigerating liquid contained in second cavity 20. Second cavity 20 contains the refrigerating liquid and its vapors. The pressure in the second cavity prior to initiating the evaporation reaction is around 30 mbar at 23° C. when the refrigerating liquid is water. To insure good efficiency of pumping by the adsorbent, it is necessary for adsorbent can 31 to be assembled and closed under vacuum, with a vacuum below 1 mbar and preferably below 0.1 mbar. In effect, the cooling reaction is initiated by depression when the evaporator (the second cavity) is put into communication with a region of greater depression (the third cavity). This cooling reaction is then maintained by the adsorbent, for example a desiccant, pumping refrigerating liquid vapors from second cavity 20 into third cavity 30.

The packaging item further includes means for initiating the cooling reaction. This reaction is set off by the bringing of the second cavity 20 and third cavity 30 into communication thereby bringing about evaporation of the refrigerant liquid in the second cavity 20 the vapor of which is pumped by a desiccant contained in the 10 third cavity 30. Thus, the packaging item includes means 40 for bringing second cavity 20 into communication with third cavity 30 integrated into a wall 25 that is common to both cavities. This common wall 25 constitutes a lid of the adsorbent can 31.

The means 40 for establishing communication can be constituted by a non-return valve that closes off an opening in common wall 25 of the second and third cavities. This valve has the particular feature of only being able to open towards the outside of adsorption cavity 30, in other words in the direction of the inside of evaporation cavity 20. The cooling reaction is set off by shifting the valve in the direction of the inside of second cavity 20. The non-return valve is operated by a pushrod 45 transmitting a displacement of at least that portion of the wall 35 of adsorbent can 31 facing wall 25 including the means 40 for establishing communication. Such means for establishing communication 40 are described in applicant's international application WO 03/0730019.

The packaging item according to the invention consequently comprises a bottle 1 the bottom 15 of which is constituted by a metal wall forming a heat exchanger. Metal wall 15 of bottle 1 should satisfy the same food contact criteria as the glass of the bottle. Using a glass bottle is justified by the nature of the product to be cooled in particular drinks such as wine or champagne. Metal bottom 15 should consequently carry a protective coating 16 suitable for food contact on its inner face to cavity 10. This coating should not constitute a thermal barrier to cooling of the drink. The coating can comprise silica or enamel. The coating can also be constituted by a thin film deposition of a material suitable for food contact, such as for example CrN. Thin-film deposition can then be performed by vacuum PVD, low pressure or plasma-assisted chemical vapor deposition (CVD), electroplating or sputtering followed by baking, in particular with products of the epoxy type. It will be understood that any other deposition suitable for food contact, in particular regarding drinks, may be suitable as a coating for metal bottom 15 in the context of this invention. Coating 16 is very thin, of the order of a few microns up to several tenths of a millimeter. In FIG. 2, it is shown enlarged and has been omitted in the other figures.

Further, the assembly of a glass bottle 1 with a metal bottom 15 should principally satisfy two constraints. Firstly, the assembly must have mechanical strength at high pressures, in other words more than 7 bars when the bottle 1 is filled with champagne and, secondly, the assembly must have good sealing qualities at these pressures.

According to a first embodiment illustrated in FIG. 2, the assembly between glass bottle 1 and heat exchanger 15 can exhibit a sealed mechanical joint 17 which simultaneously satisfies both the above constraints. Such a joint 17 may include sealing of protective coating 16 of heat exchanger 15 to the glass of bottle 1. Such sealing can for example be obtained for the case of a coating 16 which is of enamel by passage at high temperature, as will be detailed below.

Heat exchanger 15 may include an extension 22 extending over a portion of the outer glass wall of bottle 1. Metal wall 15 consequently surrounds the bottom of the bottle. The sealed mechanical joint 17 is then situated on the outer periphery of the neck of the bottle, between the glass of bottle 1 and extension 22 of heat exchanger 15. With such geometry, metal extension 22 puts the glass of bottle 1 locally under compression when the packaging item is cooling down after assembly, since the metal will expand more than the glass during passage at high temperature. Sealing properties and mechanical strength are thereby improved. Metal extension 22 of base 15 over the outer wall of bottle 1 further allows assembly of adsorbent can 31 with the base of the bottle, as will be detailed below.

According to a second embodiment illustrated in FIG. 3, assembly between glass bottle 1 and heat exchanger 15 may exhibit a mechanical joint 18 associated with a seal 19, to satisfy the two above said assembly constraints. Such a mechanical joint 18 can be constituted by folding over of the metal of base 15 into a channel 14 in the wall of bottle 1. Like in the first embodiment, heat exchanger 15 may have an extension 22 extending over a portion of the outer glass wall of bottle 1 to surround the bottom of the bottle and allow assembly of adsorbent can 31 with the base of the bottle. Metal extension 22 of base 15 can be folded over by a knurling operation into a channel 14 molded into the outer wall of bottle 1.

Seal 19 can be an elastomer O-ring arranged in a channel 13 of the wall of bottle 1. Channel 13 containing the seal 19 is preferably located below channel 14 for the mechanical joint. Seal 19 is thus compressed into a channel 13 by the extension 22 of base 15. According to one embodiment illustrated in FIG. 4, the O-ring seal 19 can also be arranged in the same channel 14 s the mechanical joint, just below where the metal turns around, at reference numeral 18, providing the mechanical joint. Channel 14 should be sufficiently deep to allow seal 19 and the folded over metal portion 18 to enter therein, but relatively shallow so that seal 19 is compressed when the extension 22 of heat exchanger 15 is folded over inside channel 14 of bottle 1.

According to a third embodiment illustrated in FIG. 5, the mechanical joint 21 can be constituted by screwing of heat exchanger 15 onto the glass wall of bottle 1. A thread can be molded into the outer wall of bottle 1 and a mating thread can be formed on the inner wall of extension 22 of heat exchanger 15.

In the embodiment of FIG. 5, seal 19 is a flat seal arranged on the edge of the wall of bottle 1. Flat seal 19 is compressed when heat exchanger 15 is screwed onto the outer wall of bottle 1. It will nevertheless be understood that such a flat seal 19 can also be employed in the embodiments of FIGS. 3 and 4, flat seal 19 being compressed when the metal 18 is folded over to penetrate inside channel 14, thereby slightly raising heat exchanger 15 in the direction of the top of bottle 1. Similarly, an O-ring seal 19 can be employed in the embodiment illustrated in FIG. 5, the O-ring seal 19 then being located inside a channel 13 below thread 21 of the wall of the bottle, it being compressed during screwing of base 15.

Regardless of the embodiment chosen for assembling a glass bottle 1 with a metal base 15, mechanical strength at high pressures and excellent sealing constraints are respected with a simple and inexpensive design. In effect, assembly of the packaging item according to the invention does not require the use of any intermediate part between heat exchanger 15 and bottle 1.

The packaging item according to the invention can be produced in the following manner.

A glass bottle 1 is made without a base using a suitable mould. Such a bottle 1 can have side walls that are flared to a greater or lesser degree depending on the envisaged applications, in other words the product to be cooled, so that the self-cooling bottle will have overall a shape similar to that of conventional bottles containing the same product.

A metal wall 15 is assembled to the glass-walls of the bottle to constitute a base on the bottle. Metal wall 15 acting as the heat exchanger can previously have been shaped to a conical shape in order to set up convection currents within the drink to be cooled. The effects of the convection currents are explained in applicant's European patent application FP-A-1 444 938.

A can 31 containing means for pumping by adsorption is assembled onto metal base 15 of bottle 1. This can 31 is preferably of metal and includes a lid 25 which, together with metal base 15 of bottle 1, defines an evaporator 20.

A refrigerant liquid is previously arranged inside evaporator 20, for example by placing an ice cube in the hollow of metal base 15 prior to closing cavity 20 with the lid 25 of can 31. Such a process is described in applicant's European patent application EP-A-1 290 387. The adsorption means contained in the cavity 30 delimited by can 31 could be constituted by a block of adsorbent shaped as described in applicant's European patent application EP-A-1 297 287. The can 31 for the adsorbent could also contain the initiation means described above, with the valve 40 arranged in the closed state on the lid 25 of can 31. Such an assembly is described in international application WO 03/073019 discussed above.

According to a first embodiment, heat exchanger 15 can be assembled to the glass of bottle 1 by sealing established between the protective coating 16 of metal base 15 and the glass of bottle 1, obtained by heating the region where extension 22 of heat exchanger 1 5 extends over the outer wall of bottle 1. Heat treatment at around 800-900° C. causes softening of the glass of the bottle and of the coating which consequently bond to each other. It is also possible to directly mold bottle 1 onto heat exchanger 15, previously coated. The base can be incorporated into the mold used to produce the bottle. The molten glass is then directly sealed onto the base 15 upon cooling.

We now have firstly the glass bottle 1 with its metal base 15 and, secondly, adsorbent can 31 with its lid 25. The can 31 o adsorbent could have side walls which extend beyond lid 25 to form a collar 32 which can come to a position surrounding extension 22 of heat exchanger 15 around the bottle 1. The outer face of heat exchanger 15 is not covered by a protective coating like its inner face. Collar 32 of can 31 can then be assembled onto the base 15 of the bottle by brazing onto lateral extension 22 of base 15. A suitable method for assembly by brazing is discussed in applicant's international application WO 03/072289.

According to a second embodiment, assembly of metal wall 15 to bottle 1 can be achieved by screwing heat exchanger 15 onto the glass wall of bottle 1, after having previously placed a seal 19 between the glass of bottle 1 and heat exchanger 15. A dot of adhesive can optionally be added to the thread when assembling the heat exchanger onto the bottle to avoid any possible unscrewing.

According to a third embodiment, assembly of metal wall 15 to the glass of bottle 1 can be performed by metal displacement, using for example a knurling wheel, of the metal of heat exchanger 15 into a channel 14 in the glass wall of bottle 1 after having previously located a seal 19 between the glass of bottle 1 and heat exchanger 15.

In the case of the second and third embodiments, it is preferable to first assemble adsorbent can 31 to heat exchanger 15 and then assemble this complete assembly into the bottom of the glass bottle. In effect, the presence of a seal 19 does not allow the adsorbent can 31 to be brazed with base 15, if this latter is already secured onto ,he glass bottle; the heat of brazing would damage elastomer seal 19.

For these embodiments, one consequently provides a can 31 of adsorbent with a lid 25 and a collar 32 and evaporator 20 is formed by assembling a wall 15 shaped into a cone onto collar 32, after having previously placed cooling liquid between lid 25 and wall 15. Metal wall 15 with the can 31 integral therewith can then be assembled into the bottom of the bottle according to one of the second or third embodiments discussed above.

The self-cooling packaging item according to the invention is used as follows.

Cooling of the content of glass bottle 1 is brought about by establishing communication between the second cavity 20 and third cavity 30 as discussed previously. Establishment of communication can be done by operating a pushbutton 35 driving in rod 45 to operate valve 40 thereby opening up a path for cooling liquid vapor pumping from the second evaporator cavity 20 to adsorbent cavity 30. The setting up of convection flow in the first cavity of bottle 10 is favored when cooling of the packaging item is initiated with the cone of heat exchanger 15 directed downwardly. Further, this arrangement of the packaging item avoids cooling liquid flowing into adsorbent can 31, as only cooling liquid vapor should be pumped.

In a particular case of a self-cooling bottle, the arrangement of the cone directed downwardly would require supporting the bottle on its stopper or holding it top-down in the hand. This position is not stable or is a nuisance to the consumer. In order to keep the self-cooling bottle in this upside-down position, it can be completely or partially kept inside a box used as the sales packaging for the bottle.

FIG. 6 illustrates another way of keeping the bottle upside-down. A stand associated with the packaging item according to the invention makes it possible to keep the bottle in this position top downwards over the duration of cooling, this being around 2 to 5 minutes. This stand 100 can be made of cardboard or plastic and has a hollow stem 110 into which the head of the bottle 1, stopper and neck, are inserted. This stem is sufficiently deep and rigid to hold the bottle standing vertically 30 head down for the duration of cooling. Once cooling is terminated, bottle 1 can then be picked up, turned over and opened to drink the content.

FIGS. 7a and 7b illustrate one alternative embodiment of stand 100. In addition to hollow stem 1 10 receiving the head of bottle 1, stand 100 has two bosses 115 (FIG. 7a) over which two inverted glasses 150 can be slipped (FIG. 7b). One single boss 115 can just as well be provided as can more than two bosses 115 on the stand 100. The glasses 150 can have feet, each foot having a crescent shaping to provide support at two arcs on opposite sides of bottle 1. Lateral retention of the bottle is thus improved during cooling. The stand is preferably square or rectangular to correspond to the end face of a box in which the self-cooling packaging item would be sold.

A self-cooling pack can thus be supplied with a bottle associated with a self-cooling device and two glasses for consumption after cooling the content of the bottle.

Obviously, the present invention is not limited to the embodiments described by way of example; thus the shape of the heat exchanger 15 of bottle 1 can be different from the cone illustrated, to have a more flattened or more pointed shape, or any other shape.

1. A self-cooling packaging item comprising:
a glass bottle constituting a first cavity containing a product to be cooled;
a second cavity forming an evaporator and containing a refrigerating liquid and its vapor;
a third cavity containing means for pumping by adsorption of said vapor;
means for putting said second and third cavities into communication;
said first and second cavities having a common metal wall forming a heat exchanger and constituting a base of the bottle.

2. The self cooling packaging item according to claim 1, wherein the heat exchanger has a food quality protective coating on its face internal to the first cavity.

3. The self-cooling packaging item according to claim 2, wherein the protective coating includes silica.

4. The self-cooling packaging item according to claim 2, wherein the protective coating includes enamel.

5. The self-cooling packaging item according to claim 1, wherein it comprises a sealed mechanical joint between the glass of the bottle sand the heat exchanger.

6. The self-cooling packaging item according to claim 5, wherein the sealed joint comprises sealing of the glass of the bottle with a protective coating of the heat exchanger.

7. The self-cooling packaging item according to claim 1, wherein it comprises a mechanical joint and a seal between the glass of the bottle and the heat exchanger.

8. The self-cooling packaging item according to claim 7, wherein the mechanical joint is constituted by folding over of the metal of the base into a channel of the wall of the bottle.

9. The self-cooling packaging item according to claim 7, wherein the mechanical joint is constituted by screwing the heat exchanger onto the glass wall of the bottle.

10. The self-cooling packaging item according to claim 7, wherein the seal is an O-ring arranged inside a channel of the wall of the bottle.

11. The self-cooling packaging item according to claim 7, wherein the seal is a flat seal arranged on an edge of the wall of the bottle.

12. The self-cooling packaging item according to claim 1, wherein the heat exchanger constituting the base of the bottle has an extension over a portion of the outer wall of the bottle.

13. The self-cooling packaging item according to claim 12, wherein a can containing the third cavity is assembled onto the bottle by brazing onto the extension of the heat exchanger.

14. A method of producing a self-cooling packaging item comprising:
supplying a glass bottle without a base;
assembling a metal wall forming a heat exchanger to the wall of the bottle to constitute a base of said bottle;
assembling a can containing means for pumping by adsorption onto the heat exchanger of the bottle, a lid of the can of adsorbent and the heat exchanger of the bottle defining an evaporator.

15. The method of production according to claim 14, wherein the step of assembling the heat exchanger to the glass of the bottle is performed by sealing the glass of the bottle to a protective coating of the heat exchanger.

16. The method of production according to claim 14, wherein the step of assembling the heat exchanger to the glass of the bottle comprises the steps of screwing the heat exchanger onto a glass wall of the bottle and placing a seal between the glass of the bottle and the heat exchanger.

17. The method of production according to claim 14, wherein the step of assembling the heat exchanger to the glass of the bottle comprises the steps of forcing the metal of the heat exchanger into a channel of the glass wall of the bottle and placing a seal between the glass of the bottle and the heat exchanger.

18. The method of production according to claim 15, wherein the can of adsorbent is assembled onto the heat exchanger after assembling the heat exchanger onto the bottle.

19. The method of production according to claim 16 wherein the can of adsorbent is assembled onto the heat exchanger prior to assembly of the heat exchanger onto the bottle.

20. The method of production according to claim 14, wherein the can of adsorbent is assembled onto the heat exchanger by brazing.

21. A self-cooling assembly comprising:
a self-cooling packaging item including:
a glass bottle constituting a first cavity containing a product to be cooled;
a second cavity firming an evaporator and containing a refrigerating liquid and its vapor;
a third cavity containing means for pumping by adsorption of said vapor
a connection means for putting said second and third cavities into communication; said first and second cavities having a common metal wall forming a heat exchanger and constituting a base of the bottle; and
a stand comprising a hollow stem adapted to receive the head of the bottle.

22. The assembly according to claim 21, wherein the stand further comprises at least one boss over which an upside-down glass can be slipped.

23. The assembly according to claim 22, wherein at least two glasses with feet are arranged on the stand, the feet being shaped so as to provide support over two arcs on opposite sides of the bottle.
